(19) United States
(12) Patent Application Publication
(10) Pub. No.: US 2026/0257835 A1
(43) Pub. Date: Sep. 3, 2026

(54) WHEEL-ACCOMMODATING PALLET SYSTEM AND CARGO-LOADING APPARATUS

(71) Applicant: AUTOGEN CO., LTD, Gyeongju-si (KR)

(72) Inventors: Jung Hwan LEE, Goyang-si (KR); Dae Hee LEE, Seoul (KR); Seung Yeob CHO, Gyeongju-si (KR)

(73) Assignee: AUTOGEN CO., LTD, Gyeongju-si (KR)

(21) Appl. No.: 19/409,786

(22) Filed: Dec. 5, 2025

(30) Foreign Application Priority Data
Dec. 5, 2024 (KR) 10-2024-0179217
Feb. 10, 2025 (KR) 10-2025-0016695
May 12, 2025 (KR) 10-2025-0061488

(51) Int. Cl. B65D 19/42; B65D 19/00; B65D 19/44

(52) U.S. Cl. CPC B65D 19/42; B65D 19/0069; B65D 19/44; B65D 2303/00; B65D 2519/00273; B65D 2519/00567; B65D 2519/00781; B65D 2519/00815

(57) ABSTRACT

A wheel-accommodating pallet system includes a plate section having an internal storage space formed in a lower portion thereof and a moving unit including front and rear wheels that is fully receivable within the internal storage space when in a folded state. A rotating member transmits rotational force to a wheel-axle assembly through a worm-shaft portion and a worm-wheel assembly to rotate the moving unit by a predetermined angle for folding or unfolding. A rotation-prevention mechanism provides double-locking engagement to prevent unintended folding or unfolding during cargo transport. By enabling complete wheel storage within the plate section, the wheel-accommodating pallet system achieves approximately a forty-percent reduction in the internal storage space compared to conventional pallets. The modular configuration facilitates maintenance, and securing the moving unit inside the plate section reduces vibration and shaking in automated warehouse environments.

### BACKGROUND

### 1. Field

The present invention relates to a wheel-accommodating pallet system used in automated warehouse systems, and more specifically, to a wheel-accommodating pallet system that incorporates a structure in which a moving unit including wheels is foldable and unfoldable and receivable within an internal storage space of a plate section, and which, when combined with a transfer cart, enables stable loading and movement of cargo.

### 2. Description of the Related Art

In the logistics industry, automated warehouse systems are increasingly being adopted to maximize space efficiency and operational efficiency. Automation systems utilizing shuttles can efficiently load and unload items of various sizes and shapes. Consequently, there is a growing need for specialized pallets that are fully compatible with shuttle systems while also enabling the stable loading and movement of items of diverse shapes and sizes.

Standard pallets with their conventional standardized sizes and shapes have several limitations, including unstable loading, incompatibility with transfer carts, and fragile structures. For instance, when cargo becomes too tall, shaking may occur within automated equipment during transport. In such cases, all operations may halt according to safety settings that trigger an automatic full stop for all devices. Furthermore, the difficulty of loading and unloading transfer carts onto pallets requires additional manpower, potentially reducing operational efficiency and negating the time and labor cost savings that are advantages of automated warehouses.

In conventional technology, goods in automated warehouses are typically loaded onto pallets and placed on shuttle devices. These shuttle devices have lifting functions, allowing them to travel along horizontal rails of storage racks while carrying the loaded goods, transferring or moving the cargo, and storing it vertically. However, when the number of transport items increases and they stack vertically, the increased height causes shaking within the automated warehouse due to the moving units. Furthermore, the conventional process of loading and unloading pallets onto and from the shuttle was difficult, leading to the limitation that despite being an automated system, additional manpower was required, resulting in low operational efficiency.

### SUMMARY

An object of the present invention is to provide a wheel-accommodating pallet system in which a transfer cart and a pallet are mutually coupled to enable easy and stable loading of cargo.

Another object of the present invention is to provide a wheel-accommodating pallet system that saves space by enabling complete storage of a moving unit inside a plate section and enhances stability by preventing accidental folding or unfolding during cargo transport through a double-locking structure.

Another object of the present invention is to provide a wheel-accommodating pallet system featuring a modular design that allows for easy and convenient maintenance by enabling repair and replacement of only damaged parts, such as a worm-wheel assembly or wheel-axle assembly, without requiring complete disassembly.

Another object of the present invention is to provide a cargo-loading apparatus that prevents shaking caused by a moving unit of a transfer cart within an automated warehouse by having the moving unit slide stably onto a pallet.

To accomplish the above objects, a cargo-loading apparatus according to an embodiment of the present invention comprises: a body defining a space for accommodating cargo; at least first moving unit and a second moving unit connected to the body and disposed beneath the body; a first plate positioned between the body and the at least first moving unit and a second moving unit and having at least one first fastening portion including vertical projections or grooves; and a second plate positioned below and facing the first plate and having at least one second fastening portion formed to be vertically fastened to the at least one first fastening portion.

The second plate may include a first rail groove along which the first moving unit slides in a Y-axis direction, and a second rail groove along which the second moving unit slides following the first moving unit.

The first rail groove and the second rail groove may each include a locking groove configured to stop sliding movement of the first and second moving units, respectively.

Each locking groove may be deeper than a corresponding rail groove to reduce acceleration of the sliding movement of the first and second moving units, and a transition portion between the rail groove and the locking groove may be inclined to reduce impact.

The first moving unit may comprise front wheels capable of rotation, and the second moving unit may comprise rear wheels incapable of rotation and vertically movable depending on a direction of the front wheel.

According to another embodiment of the present invention, a load-carrying apparatus comprises: a body defining a space for receiving a load; a plate portion connected to the body and disposed at a bottom portion of the body, the plate portion including at least one tool-receiving opening configured to receive an external lifting tool; at least two moving units disposed beneath the plate portion and configured to transport the body and plate portion while supporting the load, at least two moving units and configured to move the plate portion while folding the at least two moving units.

Each moving unit of the at least two moving units may be connected to the plate portion by a receiving portion and a hinge portion, and a spring may be disposed between a wheel-axle of the moving unit and the receiving portion, the spring being wound around a hinge-shaft portion to bias the moving unit in a folding direction.

The spring may comprise a torsion spring, a compression spring, or a leaf spring.

The folding-transfer member may comprise: a fixed member having a height smaller than a length of the moving unit and positioned between at least two of the at least two moving units; a roller member configured to transmit movement of the plate portion in a folded state as the moving unit travels; and a fixed-contact member configured to contact a folding-contact portion of the moving unit to initiate folding of the moving unit as the moving unit passes.

Contact between the moving unit and the fixed-contact member may depress a button to release a spring-locking device, allowing the moving unit to fold under a biasing force of the spring.

The moving unit may be automatically restored or manually restored to an unfolded state after use.

According to another embodiment of the present invention, a wheel-accommodating pallet system comprises: a plate section having a generally flat structure configured to carry cargo, the plate section including an internal storage space formed on a bottom side thereof; a moving unit disposed at the bottom of the plate section and foldable into the internal storage space, the moving unit including at least two front wheels configured for forward and reverse linear movement and at least two rear wheels configured for forward linear movement, reverse linear movement, and rotational movement; a rotating member comprising a handle portion and a worm-shaft portion configured to transmit rotational force; a wheel-connection portion and a worm-wheel fixing portion connecting the at least two front wheels and the at least two rear wheels; and a wheel-axle assembly including a worm-wheel assembly fixed to the worm-wheel fixing portion and meshing with the worm-shaft portion of the rotating member so as to receive rotational force and rotate the moving unit by a predetermined angle.

A lift hole may be formed on a side of the plate section and may be configured to receive forks of a forklift for lifting the plate section.

At least four bogie-mounting grooves may be formed on an upper surface of the plate section and may be configured to receive a bogie.

A motor serving as a driving source may be coupled to the handle portion to automatically provide rotational force to the rotating member.

The handle portion may include a wrench-access opening configured to receive a wrench of a fork-type robot such that rotation of the wrench folds or unfolds the moving unit.

The wheel-axle assembly may comprise: a first wheel-axle branch portion positioned along a Z-axis; and a second wheel-axle branch portion positioned along a Y-axis in a direction corresponding to the rotating member, and the rotating member may comprise two rotating arms, such that rotation of the two rotating arms about the Y-axis by approximately 180 degrees causes the two rotating arms to selectively strike and push the second wheel-axle branch portion to rotate the wheel-axle assembly approximately 90 degrees in a first direction to fold the moving unit, or to strike and push the first wheel-axle branch portion to rotate the wheel-axle assembly approximately 90 degrees in a second direction to unfold the moving unit.

The wheel-accommodating pallet system may further comprise a rotation-prevention mechanism including: a latch portion and a latch-groove portion on the rotating member; a hook portion and a hook-groove portion configured to selectively engage the latch portion or the latch-groove portion to prevent rotation of the rotating member; and a spring portion, wherein the rotation-prevention mechanism provides a double-locking structure for securing the folded or unfolded state of the moving unit.

A position of the moving unit may be fixed by engagement of the latch-groove portion with the hook portion, or by seating of the latch portion in the hook-groove portion.

A dedicated socket may be insertable into the handle portion, and leftward or rightward movement of the rotation-prevention mechanism may cause the latch portion to engage the hook-groove portion so as to permit rotation for folding or unfolding the moving unit, and removal of the dedicated socket may allow the hook portion to return by the spring portion such that the latch portion engages the hook portion and prevents rotation of the rotating member.

The wheel-accommodating pallet system according to the present invention enables complete storage of the moving unit inside the internal storage space of the plate section when not in use, thereby achieving approximately a forty-percent reduction in the internal storage space compared to conventional pallets, and provides enhanced stability by preventing accidental folding or unfolding during cargo transport through the double-locking structure.

Furthermore, the wheel-accommodating pallet system according to the present invention features a modular design that allows for repair and replacement of damaged parts, such as the worm-wheel assembly or wheel-axle assembly, without requiring complete disassembly, thereby providing simplified and convenient maintenance.

Moreover, the wheel-accommodating pallet system according to the present invention improves system stability by having the moving unit of the transfer cart fixedly coupled inside the plate section, thereby reducing shaking caused by the moving unit within the automated warehouse.

Furthermore, the wheel-accommodating pallet system according to the present invention utilizes the folding-transfer member to automatically fold the at least two moving units, thereby reducing time required for precision work and lowering labor costs to enable efficient operation of the automated warehouse.

### BRIEF DESCRIPTION OF DRAWINGS

FIG. 1 is an exploded perspective view schematically showing a wheel-accommodating pallet system according to a first embodiment of the present invention.

FIG. 2 is a perspective view schematically showing a transfer cart moved and installed on the installed pallet of FIG. 1.

FIG. 3A is a cross-sectional view taken along line III-III of the pallet and transfer cart according to the first embodiment of FIG. 2.

FIG. 3B is a cross-sectional view schematically showing the pallet and transfer cart according to the first embodiment being lifted by a forklift device from FIG. 3a.

FIG. 4A is a cross-sectional view showing a pallet and transfer cart according to a second embodiment of the present invention.

FIG. 4B is a cross-sectional view schematically showing the pallet and transfer cart according to the second embodiment being lifted by a forklift device from FIG. 4A.

FIG. 5 is a perspective view showing a loading apparatus including a transfer cart and pallet loaded on a shuttle lift that is stacked in a storage rack according to a third embodiment of the present invention.

FIGS. 6A to 6F are each bottom views showing an operation in which the transfer cart according to the third embodiment of the present invention slides and couples onto the pallet.

FIG. 7 is a cut-away side view showing a state in which the moving unit of the transfer cart according to the third embodiment of FIG. 6F slides and seats onto the pallet.

FIGS. 8A to 8C are each side views showing an operation in which the pallet according to a fourth embodiment of the present invention is transported in a folded state as the moving unit passes by with a folding-transfer member positioned in the middle.

FIG. 9 is a plan view showing a state in which wheels are unfolded in the wheel-accommodating pallet system according to a fifth embodiment of the present invention.

FIG. 10 is a partially enlarged perspective view showing a relationship between the rotating member and the worm-wheel assembly of FIG. 9.

FIG. 11 is a side view showing a state in which wheels are unfolded in the wheel-accommodating pallet system according to the fifth embodiment of the present invention.

FIG. 12 is a side view showing a state in which wheels are folded in the wheel-accommodating pallet system according to the fifth embodiment of the present invention.

FIG. 13 is a plan view and a partially enlarged perspective view showing a state in which wheels are unfolded in the wheel-accommodating pallet system according to a sixth embodiment of the present invention.

FIG. 14 is a partially enlarged perspective view showing a relationship between the rotating arms and the wheel-axle branch portions of FIG. 13.

FIG. 15 is a plan view and a partially enlarged perspective view showing a state in which wheels are folded in the wheel-accommodating pallet system according to the sixth embodiment of the present invention.

FIG. 16 is a side view and a partially enlarged view showing a state in which wheels are unfolded in the wheel-accommodating pallet system according to the sixth embodiment of the present invention.

FIG. 17 is a partially enlarged perspective view showing a relationship between the rotating member and the rotation-prevention mechanism of FIG. 16.

FIG. 18 is an operational view showing a state in which wheels are folded and unfolded in the wheel-accommodating pallet system according to the sixth embodiment of the present invention.

FIG. 19A is a side view showing a state in which the latch-groove portion of the wheel-accommodating pallet system according to the sixth embodiment of the present invention is engaged with the hook portion.

FIG. 19B is a side view showing a state in which the latch portion is seated in the hook-groove portion.

### DETAILED DESCRIPTION

Hereinafter, embodiments of the present invention will be described in detail with reference to the accompanying drawings. However, the technical spirit of the present invention is not limited to the embodiments described herein and may be embodied in other forms. The embodiments introduced herein are provided so that the disclosed content is thorough and complete and so that those skilled in the art to which this invention pertains can fully understand the spirit of the present invention.

In the specification, singular expressions include plural meanings unless the context clearly indicates otherwise. Furthermore, terms such as “comprise” or “include” mean that the features, numbers, steps, components, or combinations thereof mentioned in the specification are present, and should not be understood as excluding the possibility that one or more other features, numbers, steps, components, or combinations thereof may be additionally present or may be included.

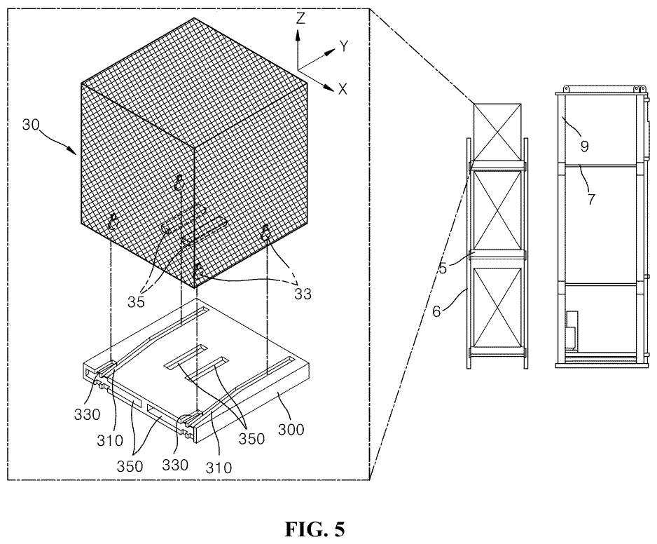

Furthermore, as used in the detailed description and claims of the present invention, the term “body” may refer to a transfer cart for accommodating cargo or a load, and the term “plate portion” may refer to a pallet. Moreover, the term “front” denotes a direction opposite to “rear,” and “sliding movement direction” may refer to movement along the Y-axis, which is orthogonal to the X-axis shown in FIG. 5.

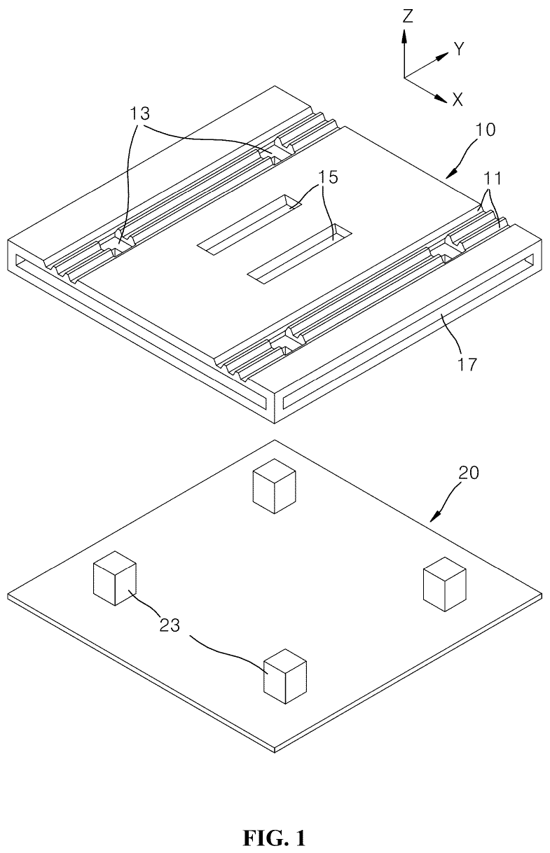

FIG. 1 is an exploded perspective view schematically showing a wheel-accommodating pallet system according to a first embodiment of the present invention. Referring to FIG. 1, a loading apparatus according to the first embodiment of the present invention may include a pallet 10 and a support fixing device 20.

The pallet 10 may have at least two moving guide grooves 11 formed on an upper surface thereof through which a transfer unit passes, guiding a path of the transfer unit as a transfer cart 30 passes. Additionally, a wheel mounting groove 13 may be further formed on the upper surface of the pallet 10 at an intermediate portion of the path of the moving guide groove 11, where wheels of the transfer unit of the transfer cart 30 are seated and fixed. Moreover, a first fastening groove 15 may be formed at a center of the upper surface of the pallet 10, and at least one lift hole 17 may be formed on a side portion of the pallet 10.

The wheel mounting groove 13 allows the transfer unit (wheel) of the transfer cart to move along the moving guide groove 11 and stop at that position. The lift hole 17 is a through hole configured to receive a lifting claw portion of a robotic forklift device for the pallet 10.

The support fixing device 20 is installed on a floor of a logistics warehouse and includes a fixed member 23 formed as a protrusion configured to interlock with the wheel mounting groove 13 of the pallet 10. The fixed members 23 are installed in a number corresponding to a number of moving units 30, and positions thereof can align with the wheel mounting grooves 13. The wheel mounting groove 13 and the fixed member 23 may each be formed with protrusions and grooves in opposite orientations. patents.

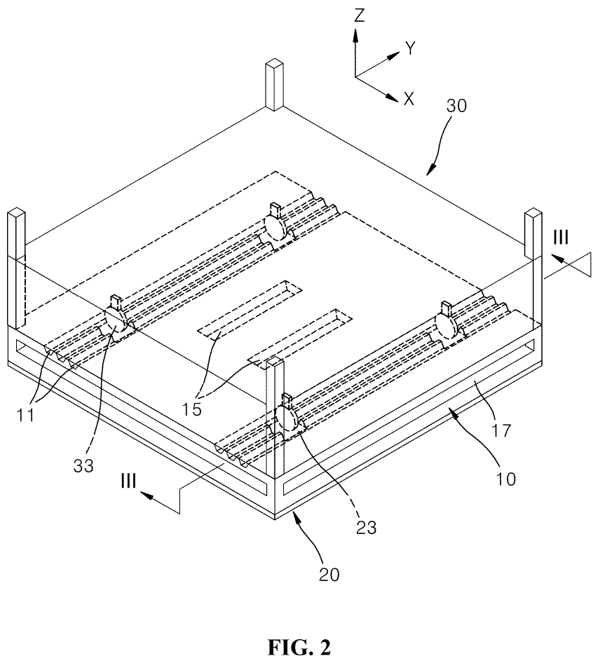

FIG. 2 is a perspective view schematically showing the transfer cart moved and installed on the installed pallet of FIG. 1. Referring to FIG. 2, the transfer cart 30 can be moved onto the installed pallet 10 shown in FIG. 1. At this time, the pallet 10 can be installed on the support fixing device 20 with the wheel mounting groove 13 and fixed member 23 fitted together. The transfer cart 30 may be formed as a cage to hold various forms of cargo 1 internally, but is not limited thereto and may be installed in various forms. The transfer cart 30 may have four transfer units 33. Front wheels among the transfer units 33 can rotate and change direction, but rear wheels cannot rotate or change direction and can only move vertically according to a direction of the front wheels.

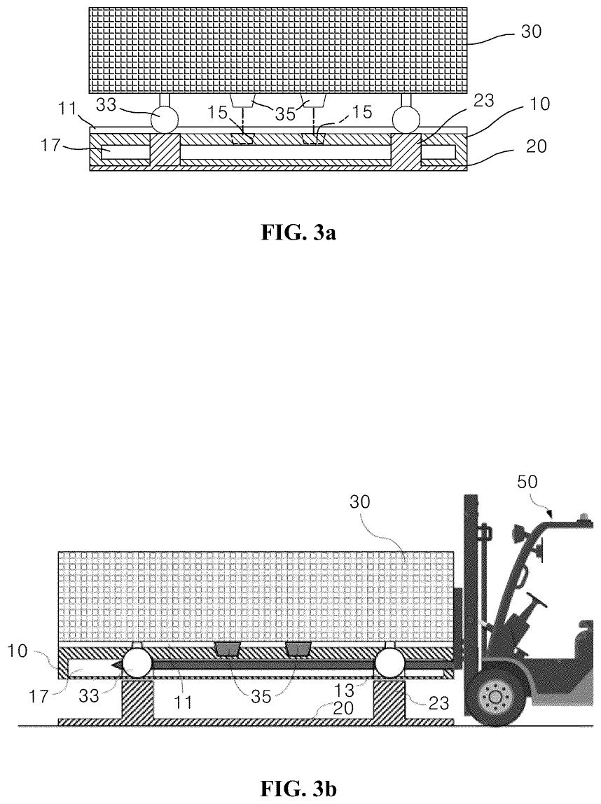

FIG. 3A is a cross-sectional view taken along line III-III of the pallet and transfer cart according to the first embodiment of FIG. 2. Referring to FIG. 3A, the transfer cart 30 is positioned on the pallet 10 installed on the support fixing device 20. The transfer cart 30 can pass over the moving guide groove 11 of the pallet 10 and stop positioned on the wheel mounting groove 13. At this time, the wheel mounting groove 13 is filled with the fixed member 23 so that the transfer unit 33 can be positioned and aligned thereon.

FIG. 3B is a cross-sectional view schematically showing the pallet and transfer cart according to the first embodiment being lifted by a forklift device from FIG. 3A. Referring to FIG. 3B, after position alignment shown in FIG. 3A is completed, a lifting gripper portion of a robot or manned forklift 50 can be inserted into the lift hole 17 of the pallet 10 to lift the pallet from the support fixing device 20. Therefore, the loading apparatus combining the transfer cart 30 according to the first embodiment and the pallet 10 reduces shaking caused by the moving unit 33 of the cart within an automated warehouse, as the moving unit 33 of the cart is fixedly coupled inside the pallet 10.patents.

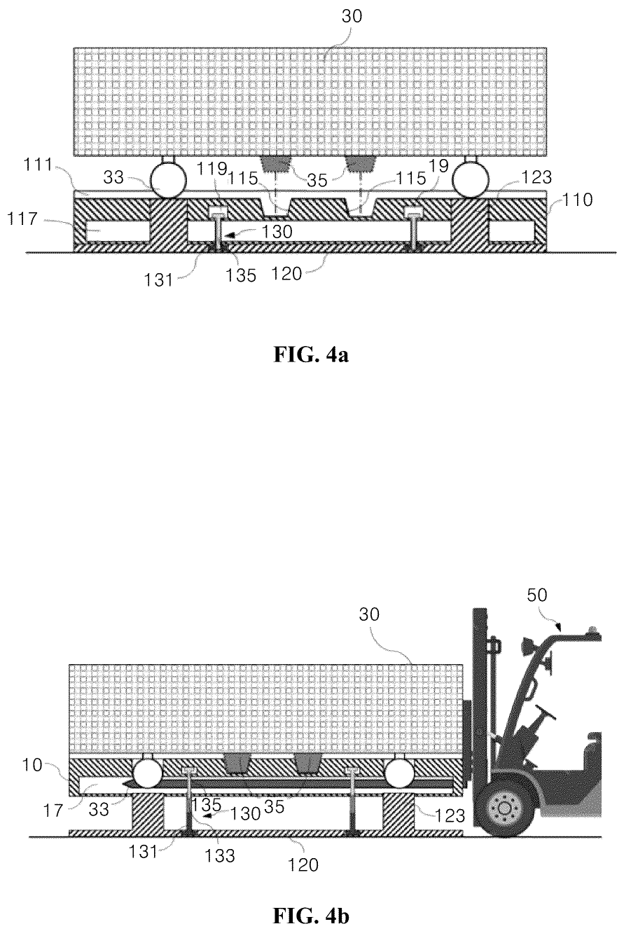

FIG. 4A is a cross-sectional view showing a pallet and transfer cart according to a second embodiment of the present invention, and FIG. 4B is a cross-sectional view schematically showing the pallet and transfer cart according to the second embodiment being lifted by a forklift device from FIG. 4A. Referring to FIG. 4A, a pallet 110 according to the second embodiment of the present invention may have two or more moving guide grooves 111, wheel mounting grooves 113, fastening grooves 115, and lift holes 117 formed therein. The pallet 110 according to the second embodiment of the present invention may have a structure where support fixing devices 120 are interconnected by connecting devices 130, which may be applicable when support fixing devices 120 cannot be separately installed on a floor of a logistics warehouse.

The connecting device 130 may include a first connecting portion 131 installed in a first connecting groove 129 formed in the support fixing device 120, and a second connecting portion 135 installed below a second connecting groove 119 formed in the pallet 110. Before lifting, the first connecting portion 131 and the second connecting portion 135 are each connected to each other and installed facing each other, and may have ‘ [symbol] ’ and ‘ [symbol] ’ shapes.

Referring to FIG. 4B, the pallet 110 is lifted from the support fixing device 120 using the forklift device 50. At this time, the connecting device 130 may be constructed as a telescopic structure in which a third connecting portion 133 is further added between the first connecting portion 131 and the second connecting portion 135, allowing the pallet 110 to be lifted from the support fixing device 120 while simultaneously aligning its position. The third connecting portion 133 may be manufactured in a straight ‘ [symbol] ’ shape and positioned between the first connecting portion 131 and the second connecting portion 135. The connecting device 130 may be manufactured from a material capable of exerting sufficient force to lift the transfer cart 30.

FIG. 5 is a perspective view showing a loading apparatus including a transfer cart and pallet loaded on a shuttle lift that is stacked in a storage rack according to a third embodiment of the present invention. Referring to FIG. 5, a first cargo-loading apparatus 100 according to the third embodiment of the present invention may include a transfer cart 30 and a pallet 300. The transfer cart 30 may include a body 31 and first and second moving units 33a, 33b.

The body 31 may define a space for accommodating a load 1. The first and second moving units 33a, 33b may be connected to the body 31 and disposed beneath the body, and may include at least two units for transporting the load 1.

The transfer cart 30 has a first plate positioned between the body 31 and the first and second moving units 33a, 33b, and at least one first fastening portion 35 may be formed thereon including vertical projections or grooves to enable interconnection with the pallet 300. The pallet 300 is positioned below and faces the transfer cart 30 and may include at least one second fastening portion 350 formed to be vertically fastened to the first fastening portion 35.

The pallet 300 includes a first rail groove 310 formed therein along which a first moving unit 33a positioned at one end slides in a Y-axis direction toward a front, and a second rail groove 330 formed therein along which a second moving unit 33b slides following the first moving unit 33a and settles.

A locking groove 350 may be included in each of the first rail groove 310 and second rail groove 330 configured to stop sliding movement of the first moving unit 33a and second moving unit 33b. The locking groove 350 may be deeper than the first rail groove 310 and the second rail groove 330 to reduce acceleration of the sliding movement of the first moving unit 33a and the second moving unit 33b. To reduce impact, a transition portion between the first rail groove 310 and the locking groove 350, and between the second rail groove 330 and the locking groove 350, may be inclined. The locking groove 350 may have different heights on both inclined surfaces.

The first moving unit 33a may comprise a front wheel of the transfer cart 30, and the front wheel is capable of rotation. The second moving unit 33b may comprise rear wheels incapable of rotation and vertically movable only according to a direction of the front wheel.

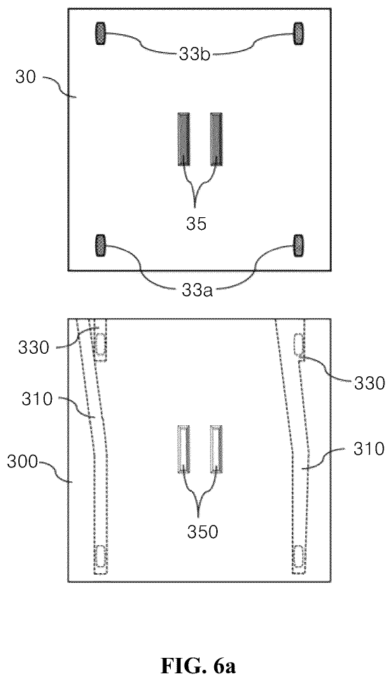

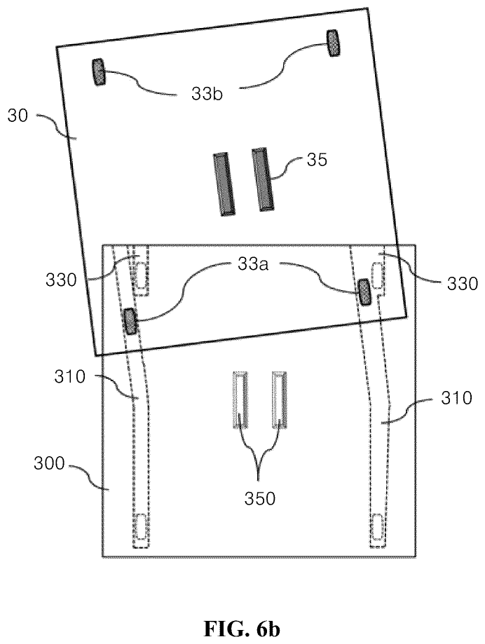

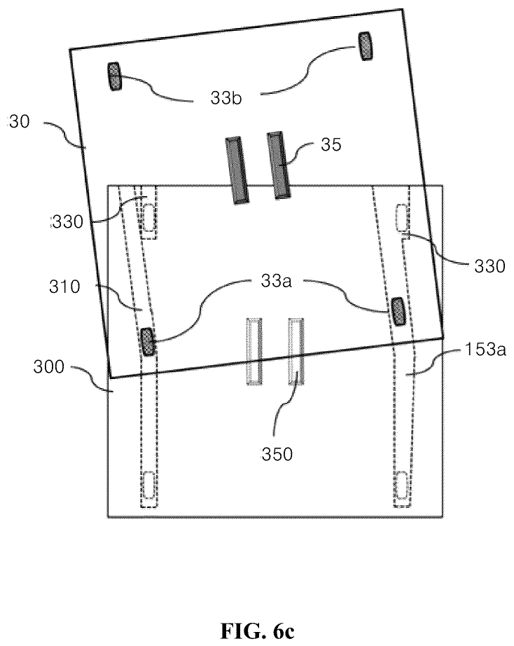

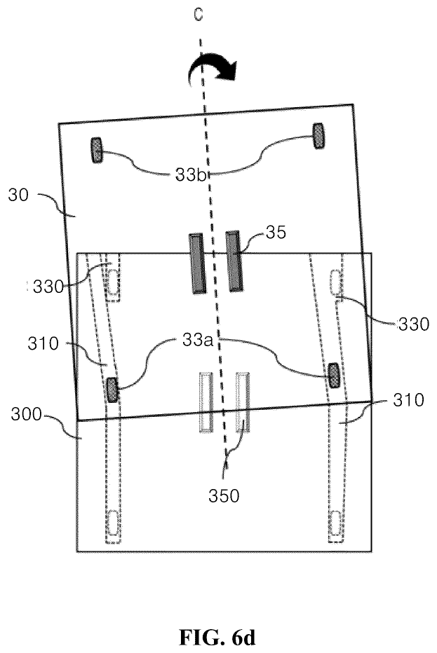

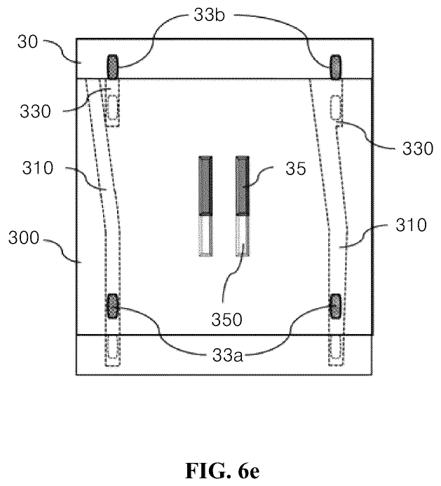

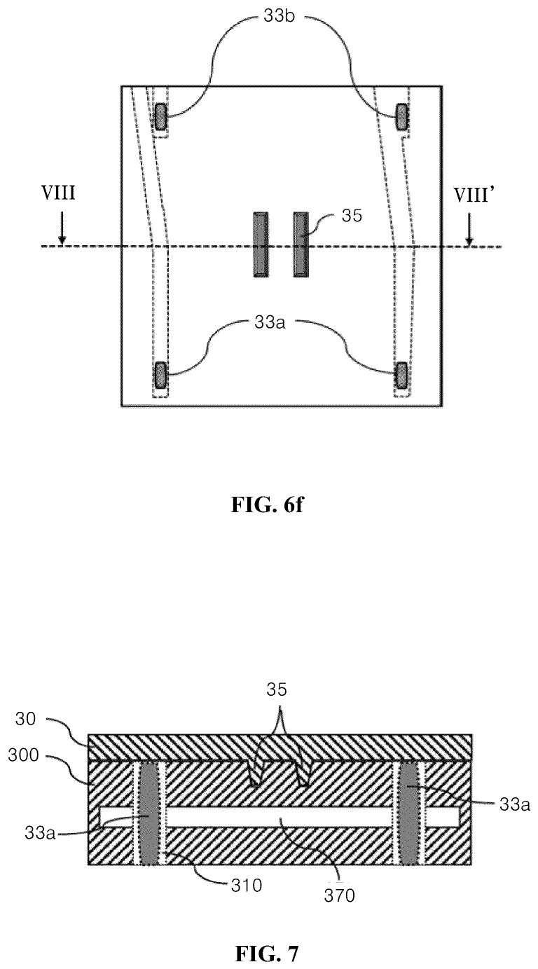

FIGS. 6A through 6F are each bottom views showing an operation in which the transfer cart according to the third embodiment of the present invention slides and couples onto the pallet. Referring to FIGS. 6A through 6F, the first moving unit 33a of the transfer cart 30 can enter the first rail groove 310 by sliding forward as a leading unit. The first rail groove 310 is formed as two paths to allow two first moving units 33a to slide parallel to each other while tilted to the left or right. Upon reaching a central axis of the pallet 300, an inclination of the first rail groove 310 can be formed to be inclined in parallel and facing each other so as to match the inclination of the transfer cart 30 and the pallet 300. This first rail groove 310 is interrupted at a specific position to stop and secure the two first moving units 33a. Meanwhile, the second moving unit 33b of the transfer cart 30 comprises two parts and can follow the first moving unit 33a, stopping and settling on the second rail groove 330. The second rail groove 330 may be formed as a straight line of shorter length than the first rail groove 310, and may either merge with the first rail groove 310 or be formed as a separate path.

FIG. 6F shows the transfer cart 30 accurately coupled and seated on the pallet 300. When the first moving unit 33a and the second moving unit 33b are each engaged and seated in the first rail groove 310 and the second rail groove 330, respectively, the first fastening portion 35 and the second fastening portion 350, each ultimately formed by at least one of a groove and a protrusion, can be mutually engaged and fastened. At this time, shapes of the first fastening portion 35 and the second fastening portion 350 are not limited to the drawings and can be manufactured in various shapes, such as vertical or horizontal directions.

FIG. 7a is a front view showing the transfer cart according to the third embodiment of FIG. 6B in a state where it is entering to perform a sliding movement on the pallet. Referring to FIG. 7a, when the first moving unit 33a of the transfer cart 30 slides forward into the first rail groove 310 as a leading unit, at least one first fastening portion 35 formed by projections between the first moving units 33a can slide while suspended above the pallet 300.

FIG. 7b is a cross-sectional front view showing the transfer cart according to the third embodiment of FIG. 6F coupled and seated on the pallet. Referring to FIG. 7b, when the transfer cart 30 and the pallet 300 are finally coupled, at least one first fastening portion 35 formed as a protrusion can be seated and coupled into at least one second fastening portion 350 formed as a groove in the pallet 300. Therefore, as the transfer cart 30 and the pallet 300 are mutually fastened, it is possible to prevent the load from swaying even when the load 1 is stacked high.

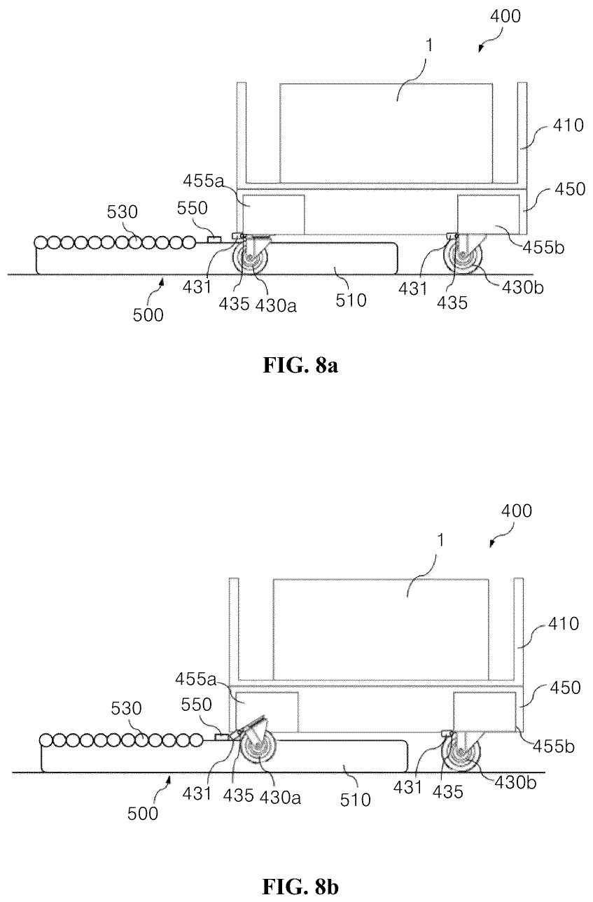

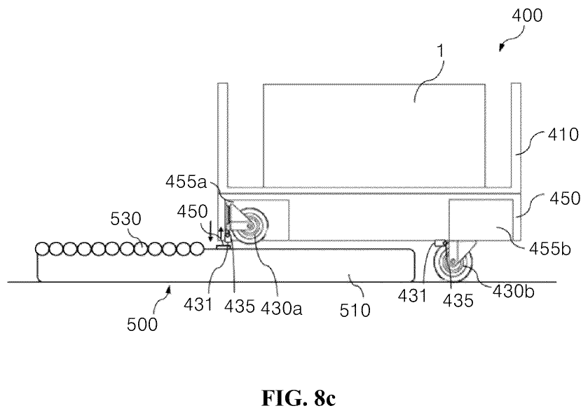

FIGS. 8A to 8C are each side views showing an operation of a second loading apparatus 300 according to a fourth embodiment of the present invention, wherein a folding-transfer member 500 is positioned in the middle and changes to a folded state while being transported as a moving unit 330 passes by. Referring to FIGS. 8A to 8C, a load-carrying apparatus 400 for a load 1 according to the fourth embodiment of the present invention may include a body 410, a plate portion 450, a moving unit 430, and a folding-transfer member 500.

The body 410 may define a space for accommodating the load 1, and may include a horizontal support section and a vertical support section, and may have a cage shape depending on contents of the load 1.

The plate portion 450 is connected to the body 410 and disposed at a bottom portion of the body 410. The plate portion 450 may include at least one tool-receiving opening 457 configured to receive an external tool unit, such as a robotic forklift or a manned forklift, to enable lifting and movement.

The moving unit 430 comprises at least two units disposed beneath the plate portion 450 and configured to transport the body 410 and plate portion 450 carrying the load 1. The at least two moving units 430 are foldable and unfoldable. Specifically, each moving unit 430 is connected to the plate portion 450 by a receiving portion 455 and a hinge portion (hinge shaft) 435, and a spring (not shown) is disposed between a wheel-axle of the moving unit 430 and the receiving portion 455. At this time, the spring may be wound around a hinge-shaft portion 435 to provide force for the moving unit 430 to rotate in a folding direction. The spring may comprise various types such as a torsion spring, a compression spring, or a leaf spring. Specifically, when a leaf spring is applied, the moving unit 430 is mounted on top of the leaf spring (elastic metal plate), and the leaf spring allows the moving unit 430 to fold using its elasticity when the moving unit 430 contacts a fixed-contact member 550. The spring itself provides restoring force, eliminating a need for a separate return mechanism. Here, the receiving portion 455 is a space within the plate portion 450 capable of accommodating the moving unit 430, the spring, and other components.

The folding-transfer member 500 is positioned within a spacing and at a height of at least two moving units 430 and is configured to move the plate portion 450 while folding the moving units 430. The folding-transfer member 500 may comprise a fixed member 510, a roller member 530, and a fixed-contact member 550. A height of the fixed member 510 may be approximately 5 to 10 cm lower than a length of the moving unit 430, and the fixed member 510 may have dimensions that allow it to be placed between at least two moving units 430 and fit within a space between them. The roller member 530 enables the plate portion 450 to transport in a folded state, and the fixed-contact member 550 can contact a folding-contact portion 431 as the moving unit 430 passes, causing the moving unit 430 to fold.

FIG. 8A shows that the moving unit 430 can slide a certain distance over the folding-transfer member 500 before folding. FIG. 8B shows that as the second loading apparatus 400 passes over the folding-transfer member 500, the moving unit 430 can contact the fixed-contact member 550, slide, and then rotate around the hinge portion 435 to fold. Upon contact with the fixed-contact member 550, the moving unit 430 rotates around the hinge-shaft portion 435 to fold, assisted by the spring. More specifically, upon contact with the fixed-contact member 550, a button (in a form of a protrusion) is pressed, releasing a spring-locking device, allowing the moving unit 430 to fold under a biasing force of the spring. After use, the moving unit 430 can be automatically restored or manually restored. At this time, a folding-contact portion 431 installed on the moving unit 430 can also be pressed by the button (protrusion shape) engaging with it, allowing a compression spring to return to its original position. When manually designed, a separate spring can be added to the folding action to provide restoring force. Therefore, adding a locking device ensures stability, and adjusting spring strength allows control over folding sensitivity.

Accordingly, the load-carrying apparatus 400 for transporting the load 1 according to the fourth embodiment of the present invention comprises the body 410, the plate portion 450, and the moving unit 430. By maintaining the moving unit 430 in a foldable state during movement, the load-carrying apparatus 400 reduces time required for precision work and lowers labor costs, thereby enabling efficient operation of an automated warehouse.

As used in the detailed description and claims of the present invention, the term “plate portion” may refer to a pallet, which is a lower portion of the transfer cart. Furthermore, the term “front” may be denoted as “F” in the drawings, and the term “rear” may be denoted as “B” in the drawings, representing an opposite concept of “front”.

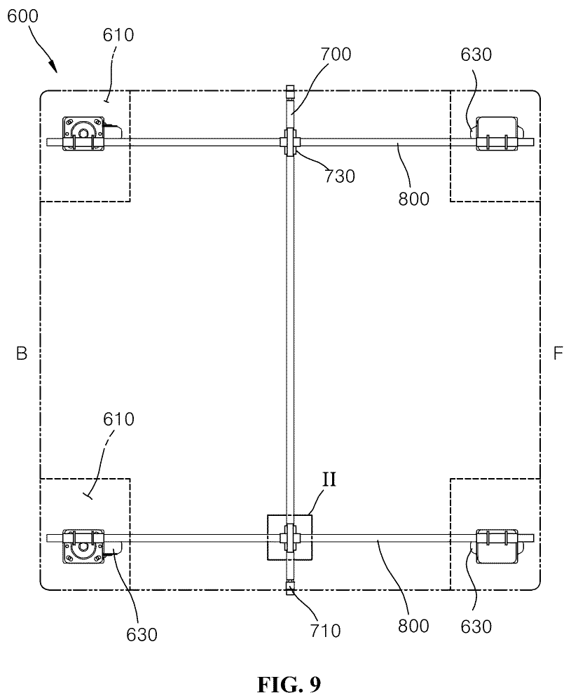

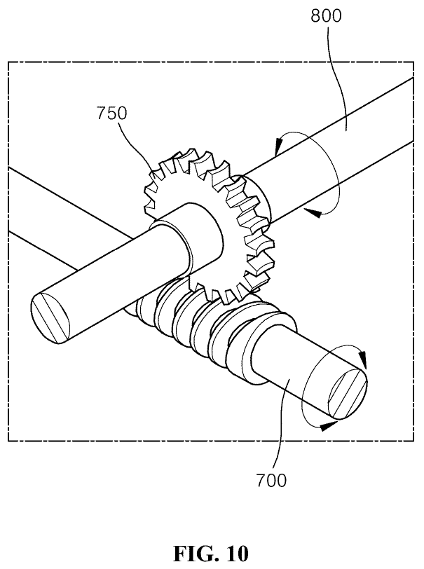

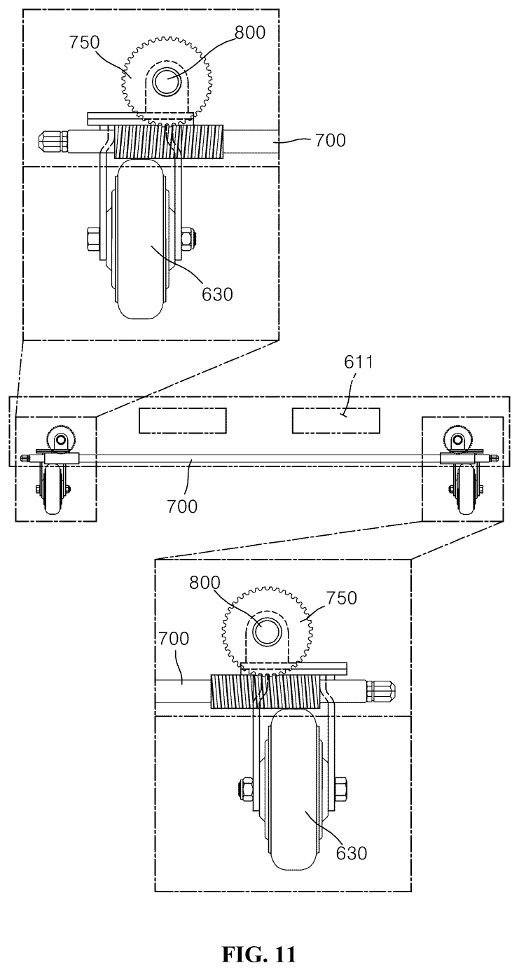

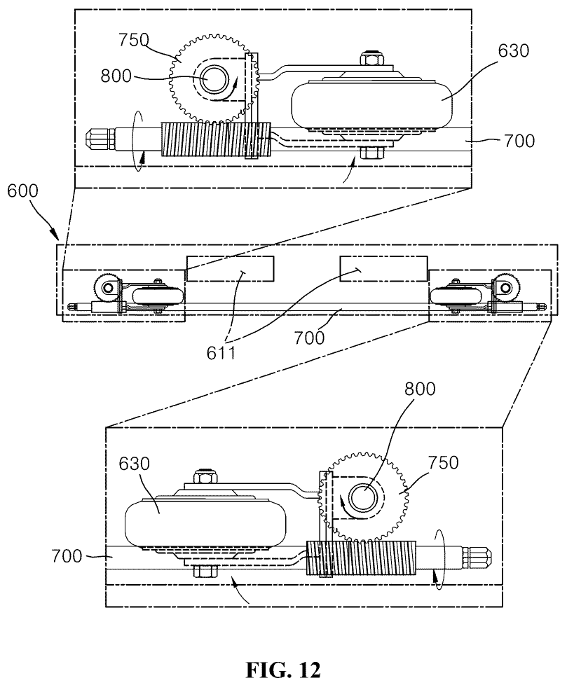

FIG. 9 is a plan view showing a state in which wheels are unfolded in the wheel-accommodating pallet system according to a fifth embodiment of the present invention. FIG. 10 is a partially enlarged perspective view showing a relationship between the rotating member and the worm-wheel assembly of FIG. 9. FIG. 11 is a side view showing a state in which wheels are unfolded in the wheel-accommodating pallet system according to the fifth embodiment of the present invention. FIG. 12 is a side view showing a state in which wheels are folded in the wheel-accommodating pallet system according to the fifth embodiment of the present invention.

As shown in FIGS. 9 through 12, a wheel-accommodating pallet system 600 according to the fifth embodiment comprises a plate section 610, a moving unit 630, a rotating member 700, and a wheel-axle assembly 800.

The plate section 610 is a plate-shaped structure forming a basic structure of the pallet and has a generally flat structure configured to carry cargo. An upper surface has a flat structure for loading items, a lower interior has an internal storage space 611 for accommodating the moving unit 630, and a lift hole 613 is formed on a side and is configured to receive forks of a forklift for lifting. The internal storage space 611 connects upper and lower parts of the plate section 610, allowing the moving unit 630 to be fully stored in a folded state.

The moving unit 630 is disposed at a bottom of the plate section 610 and is foldable into the internal storage space 611. The moving unit 630 includes at least two front wheels 631 configured for forward and reverse linear movement and at least two rear wheels 633 configured for forward linear movement, reverse linear movement, and rotational movement.

The rotating member 700 comprises a handle portion 710 and a worm-shaft portion 730. The handle portion 710 is a part where a user can apply rotational force; rotating the handle portion 710 transmits rotational force to the worm-shaft portion 730. The handle portion 710 can be operated manually, but is not limited thereto; a motor serving as a driving source may be coupled to the handle portion 710 to automatically provide rotational force to the rotating member 700.

When using a fork-type robot, the wheel-accommodating pallet system 600 according to the fifth embodiment is lifted by inserting into the lift hole 613, and a wrench from the fork-type robot can be inserted into a wrench-access opening (not shown) formed in the handle portion 710 of the rotating member 700 that operates in conjunction with the moving unit 630. Turning the wrench causes the moving unit 630 to fold or unfold.

Referring to FIG. 10, the worm-shaft portion 730 is machined into a gear shape to mesh with a worm-wheel assembly 850 to transmit rotational motion. The wheel-axle assembly 800 is a circular rod member connecting the front wheel 631 located in an “F” direction and the rear wheel 633 located in a “B” direction, and includes a wheel-connection portion 810 and a worm-wheel fixing portion 830. The wheel-connection portion 810 connects and supports the front wheel 631 and the rear wheel 633, while the worm-wheel fixing portion 830 fixes the worm-wheel assembly 850. The worm-wheel assembly 850 is fixed to the worm-wheel fixing portion 830 and meshes with the worm-shaft portion 730 of the rotating member 700 so as to receive rotational force and rotate the wheel-axle assembly 800 by a predetermined angle.

An operating principle of the wheel-accommodating pallet system 600 according to the fifth embodiment is as follows. When a user rotates the handle portion 710, rotational force is transmitted to the worm-wheel assembly 850 via the worm-shaft portion 730. As the worm-wheel assembly 850 rotates, the wheel-axle assembly 800 rotates, thereby enabling the front wheel 631 and the rear wheel 633 of the moving unit 630 to transition from a folded state shown in FIG. 12 to an unfolded state shown in FIG. 11, or vice versa.

Referring to FIG. 11, with all four moving units 630 positioned at corners of the wheel-accommodating pallet system 600 fully extended, the pallet can move freely on the wheels. Conversely, FIG. 12 shows the wheels in a folded state. At this time, the moving units 630 are fully stowed within the internal storage space 611 of the plate section 610, allowing the pallet to rest stably on a floor. This structure provides stability when loading cargo while also offering an advantage of easily unfolding the wheels for movement when needed.

Referring to FIGS. 11 and 12, at least four bogie-mounting grooves 615 may be further formed on an upper surface of the plate section 600 and are configured to receive a bogie. The bogie (not shown) installed in the bogie-mounting groove 615 may comprise four support members (not shown), and the support members, designed to carry vehicles or large cargo, can be fixed to the upper surface of the pallet below using various forms such as screws or protrusions. The bogie may be detachable or integral with the pallet system 600. If detachable, the bogie can be hinged like a box and folded flat for storage.

Thus, the wheel-accommodating pallet system 600 according to the fifth embodiment enables folding and unfolding of the wheels with simple operation, significantly improving logistics movement efficiency in industrial settings.

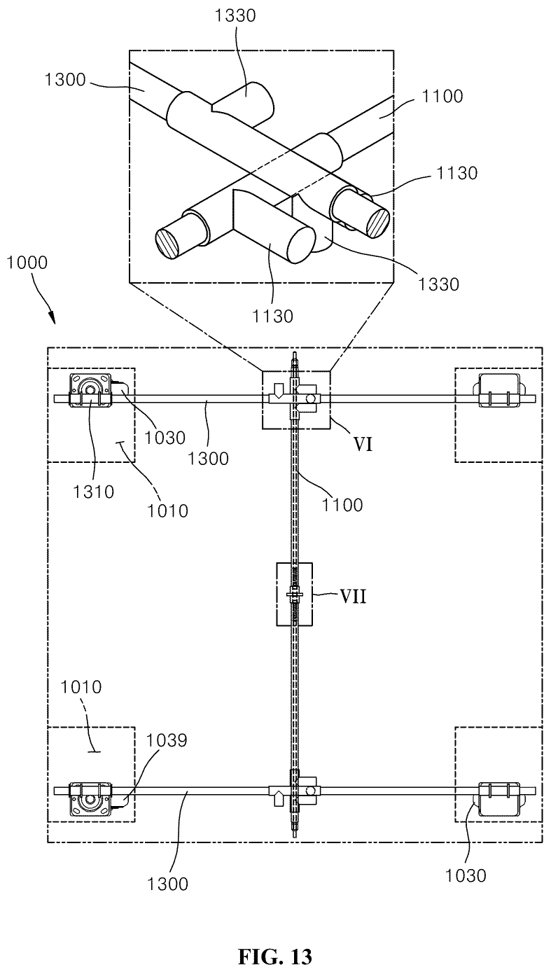

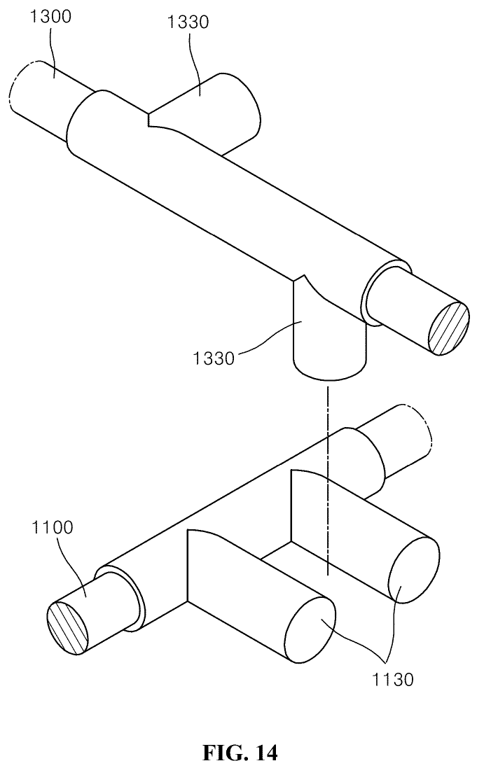

FIG. 13 is a plan view and a partially enlarged perspective view showing a state in which wheels are unfolded in the wheel-accommodating pallet system according to a sixth embodiment of the present invention. FIG. 14 is a partially enlarged perspective view showing a relationship between the rotating arms and the wheel-axle branch portions of FIG. 13.

A wheel-accommodating pallet system 1000 according to the sixth embodiment of the present invention further adds double stability in folded and/or unfolded states. The wheel-accommodating pallet system 1000 comprises a plate section 1010, a moving unit 1030, a rotating member 1100, and a wheel-axle assembly 1300, each having the same functions and roles as in the fifth embodiment.

Referring to FIG. 14, the wheel-axle assembly 1300 positioned on an X-axis is orthogonal to a Y-axis, and may comprise a first wheel-axle branch portion 1330 and a second wheel-axle branch portion 1350 each having a predetermined length. Specifically, the first wheel-axle branch portion 1330 is positioned along a Z-axis at a bottom of the wheel-axle assembly 1300, and the second wheel-axle branch portion 1350 may be positioned along the Y-axis in a direction corresponding to the rotating member 1100.

The rotating member 1100 comprises two rotating arms 1130 having a predetermined length and extending on opposite sides of the X-axis with the first wheel-axle branch portion 1330 positioned between them. The two rotating arms 1130 may be positioned on the X-axis, which is orthogonal to the Y-axis on which the rotating member 1100 is located. Rotating a handle portion 1110 of the rotating member 1100 counterclockwise allows the two rotating arms 1130 to rotate approximately 180 degrees about the Y-axis.

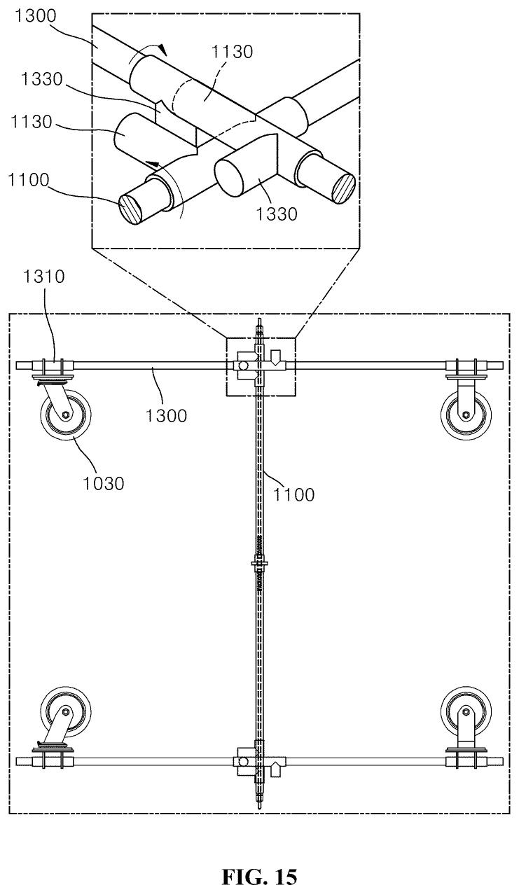

FIG. 15 is a plan view and a partially enlarged perspective view showing a state in which wheels are folded in the wheel-accommodating pallet system according to the sixth embodiment of the present invention. Referring to FIG. 15, rotating the handle portion 1110 of the rotating member 1100 counterclockwise by approximately 180 degrees allows the two rotating arms 1130 to rotate about the Y-axis, thereby striking and pushing the second wheel-axle branch portion 1350 downward. At this time, the wheel-axle assembly 1300 rotates approximately 90 degrees in a first direction (clockwise), positioning the second wheel-axle branch portion 1350 downward from the Y-axis toward the Z-axis. The two rotating arms 1130 can then grasp and secure the second wheel-axle branch portion 1350. That is, as the two rotating arms 1130 rotate about the Y-axis, force pushing the second wheel-axle branch portion 1350 downward is transmitted to the wheel-axle assembly 1300, causing it to rotate clockwise by approximately 90 degrees. Consequently, a front wheel 1031 and a rear wheel 1033 of the moving unit 1030 can be folded inward by rotating approximately 90 degrees and being accommodated within the internal storage space 1011.

Meanwhile, to unfold the wheels of FIG. 13 while the wheels of FIG. 15 are folded, the handle portion 1110 of the rotating member 1100 can be rotated clockwise by approximately 180 degrees so that the two rotating arms 1130 strike and push down the first wheel-axle branch portion 1330. This force is transmitted to the wheel-axle assembly 1300, causing it to rotate approximately 90 degrees in a second direction (counterclockwise). This allows the front wheel 1031 and the rear wheel 1033 of the moving unit 1030 to rotate approximately 90 degrees outward from the internal storage space 1011 and unfold. A direction in which the moving unit 1030 folds and unfolds, as shown in FIGS. 14 to 16, may always coincide with a direction in which the first wheel-axle branch portion 1330 is positioned.

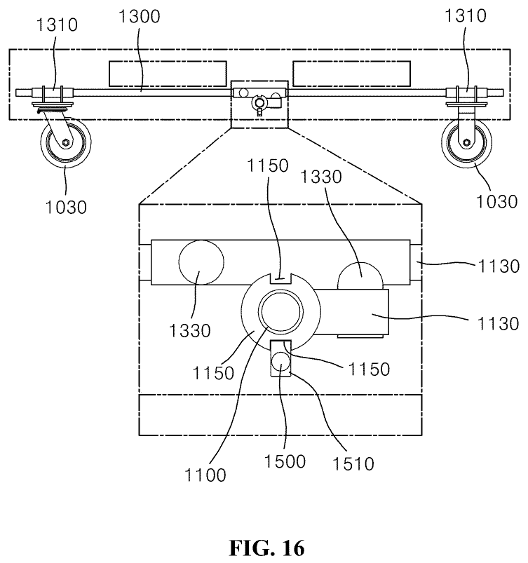

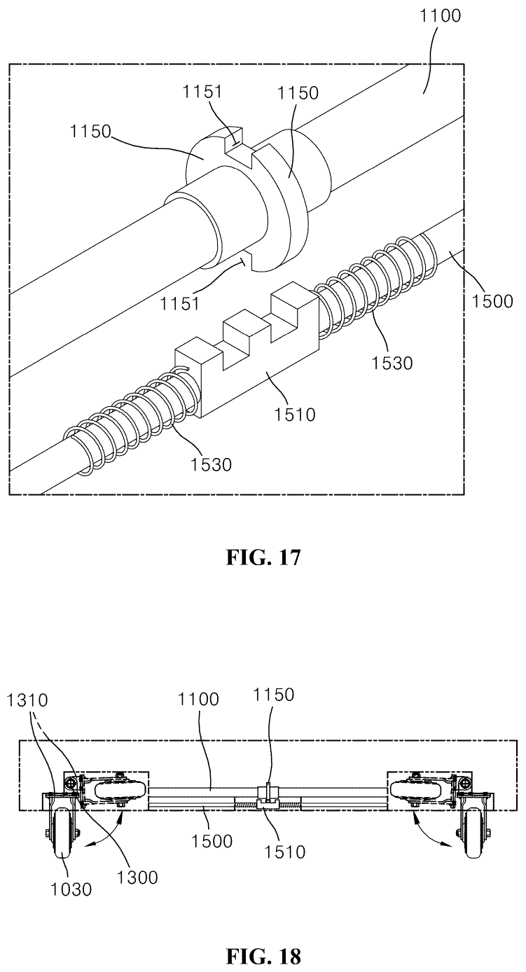

FIG. 16 is a side view and a partially enlarged view showing a state in which wheels are unfolded in the wheel-accommodating pallet system according to the sixth embodiment of the present invention. FIG. 17 is a partially enlarged perspective view showing a relationship between the rotating member and the rotation-prevention mechanism of FIG. 16. FIG. 18 is an operational view showing a state in which wheels are folded and unfolded in the wheel-accommodating pallet system according to the sixth embodiment of the present invention.

Referring to FIGS. 16 and 17, the wheel-accommodating pallet system 1000 further comprises a rotation-prevention mechanism 1500 including a latch portion 1150 and a latch-groove portion 1151 on the rotating member 1100, a hook portion 1510 and a hook-groove portion 1511 configured to selectively engage the latch portion 1150 or the latch-groove portion 1151 to prevent rotation of the rotating member 1100, and a spring portion 1530. The rotation-prevention mechanism 1500 provides a double-locking structure for securing the folded or unfolded state of the moving unit 1030. The hook portion 1510 engages with the latch-groove portion 1151 of the rotating member 1100 to prevent rotation of the rotating member 1100. The hook-groove portion 1511 is a groove into which the latch portion 1150 can be seated, used to maintain the wheels in either a folded or unfolded state. The spring portion 1530 provides elastic force to the rotation-prevention mechanism 1500, enabling the hook portion 1510 to securely engage with the latch-groove portion 1151.

Referring to FIG. 18, an operating principle of the wheel-accommodating pallet system 1000 is as follows. When the wheels are in a folded state, if the rotating member 1100 rotates due to external pressure or manipulation, rotational motion of the rotating member 1100 is transmitted to the wheel-axle assembly 1300 via the two rotating arms 1130. Consequently, the wheel-axle assembly 1300 moves, causing the front wheel 1031 and the rear wheel 1033 of the moving unit 1030 to extend out of the internal storage space 1011 and unfold.

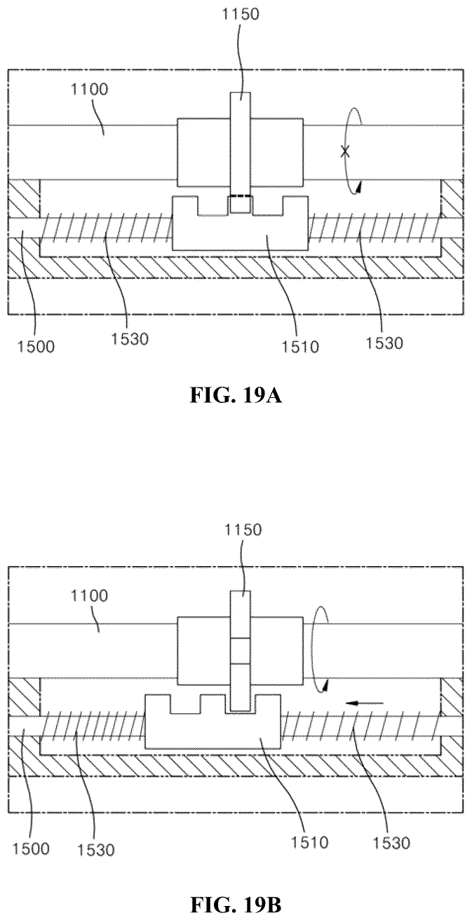

FIG. 19A is a side view showing a state in which the latch-groove portion of the wheel-accommodating pallet system according to the sixth embodiment of the present invention is engaged with the hook portion. FIG. 19B is a side view showing a state in which the latch portion is seated in the hook-groove portion.

Referring to FIGS. 19A and 19B, a position of the moving unit 1030 is fixed by engagement of the latch-groove portion 1151 of the latch portion 1150 with the hook portion 1510 of the rotation-prevention mechanism 1500, or by seating of the latch portion 1150 in the hook-groove portion 1511. FIG. 19A shows the latch-groove portion 1151 engaged with the hook portion 1510 to maintain the wheels in either a folded or unfolded state. FIG. 19B shows the latch portion 1150 engaged with the hook-groove portion 1511.

A dedicated socket 1700 is insertable into the handle portion 1110, and when the dedicated socket 1700 is inserted into the handle portion 1110 on a left or right side and the rotation-prevention mechanism 1500 is pushed in a leftward or rightward direction, the latch portion 1150 engages the hook-groove portion 1511, becoming rotatable, so as to permit rotation for folding or unfolding the moving unit 1030.

If the dedicated socket 1700 is removed, the spring portion 1530 causes the hook portion 1510 to return, and the latch portion 1150 engages with the hook portion 1510. This changes the rotating member 1100 to a non-rotatable state, which can also prevent the wheel-axle assembly 1300 from rotating. Use of the dedicated socket 1700 is not typically required under normal conditions but can be used to prevent malfunction of the pallet system 1000 caused by unexpected external impacts or foreign object entanglement.

When using a fork-type robot, the wheel-accommodating pallet system 1000 according to the sixth embodiment is lifted by inserting forks into a lift hole 1013, and a wrench (not shown) from the fork-type robot is inserted into a wrench-access opening formed in the handle portion 1110 of the rotating member 1100 that operates in conjunction with the moving unit 1030. Turning the wrench causes the moving unit 1030 to fold or unfold, enabling an unmanned automated system to transport and move logistics.

Therefore, the wheel-accommodating pallet system 1000 can secure both mobility and stability by folding or unfolding the wheels as needed. When the wheels are folded, the pallet rests stably on a floor, providing stability during goods loading. When the wheels are unfolded, easy movement is possible, enhancing work efficiency.

Furthermore, a combination structure of the rotation-prevention mechanism 1500 and the latch portion 1150 enables stable maintenance of a state of the wheels, preventing unintended folding or unfolding of the wheels. The spring portion 1530 contributes to stably maintaining this engaged state, allowing the folding or unfolding state of the moving unit 1030 to be maintained until a user intentionally applies force as needed.

Furthermore, the wheel-accommodating pallet system 1000 can be utilized in various industrial settings such as logistics warehouses, production lines, and storage facilities. Since the wheels can be fully stored inside the pallet, the wheel-accommodating pallet system 1000 offers high space utilization efficiency and prevents safety accidents caused by protruding wheels.

The above embodiments are exemplary only, and various modifications and other equally valid embodiments are possible from them by a person having ordinary knowledge in the technical field to which the invention belongs. The true technical scope of the invention will therefore be determined by the technical idea of the invention as recited in the claims.

What is claimed is:

1. A wheel-accommodating pallet system comprising:
a plate section having a generally flat structure configured to carry cargo, the plate section including an internal storage space formed on a bottom side thereof;
a moving unit disposed at the bottom of the plate section and foldable into the internal storage space, the moving unit including at least two front wheels configured for forward and reverse linear movement and at least two rear wheels configured for forward linear movement, reverse linear movement, and rotational movement;
a rotating member comprising a handle portion and a worm-shaft portion configured to transmit rotational force;
a wheel-connection portion and a worm-wheel fixing portion connecting the front wheels and the rear wheels; and
a wheel-axle assembly including a worm-wheel assembly fixed to the worm-wheel fixing portion and meshing with the worm-shaft portion of the rotating member so as to receive rotational force and rotate the moving unit by a predetermined angle.

2. The wheel-accommodating pallet system of claim 1, wherein a lift hole is formed on a side of the plate section and is configured to receive forks of a forklift for lifting the plate section.

3. The wheel-accommodating pallet system of claim 1, wherein at least four bogie-mounting grooves are formed on an upper surface of the plate section and are configured to receive a bogie.

4. The wheel-accommodating pallet system of claim 1, wherein a motor serving as a driving source is coupled to the handle portion to automatically provide rotational force to the rotating member.

5. The wheel-accommodating pallet system of claim 1, wherein the handle portion includes a wrench-access opening configured to receive a wrench of a fork-type robot such that rotation of the wrench folds or unfolds the moving unit.

6. The wheel-accommodating pallet system of claim 1, wherein the wheel-axle assembly comprises:
a first wheel-axle branch portion positioned along a Z-axis; and
a second wheel-axle branch portion positioned along a Y-axis in a direction corresponding to the rotating member,
and wherein the rotating member comprises two rotating arms,
such that rotation of the rotating arms about the Y-axis by approximately 180 degrees causes the rotating arms to selectively strike and push the second wheel-axle branch to rotate the wheel-axle assembly approximately 90 degrees in a first direction to fold the moving unit, or to strike and push the first wheel-axle branch to rotate the wheel-axle assembly approximately 90 degrees in a second direction to unfold the moving unit.

7. The wheel-accommodating pallet system of claim 6, further comprising a rotation-prevention mechanism including:
a latch portion and a latch-groove portion on the rotating member;
a hook portion and a hook-groove portion configured to selectively engage the latch portion or the latch-groove portion to prevent rotation of the rotating member; and
a spring portion,
wherein the rotation-prevention mechanism provides a double-locking structure for securing the folded or unfolded state of the moving unit.

8. The wheel-accommodating pallet system of claim 7, wherein a position of the moving unit is fixed by engagement of the latch-groove portion with the hook portion, or by seating of the latch portion in the hook-groove portion.

9. The wheel-accommodating pallet system of claim 7, wherein a dedicated socket is insertable into the handle portion, and wherein leftward or rightward movement of the rotation-prevention mechanism causes the latch portion to engage the hook-groove portion so as to permit rotation for folding or unfolding the moving unit, and removal of the dedicated socket allows the hook portion to return by the spring portion such that the latch portion engages the hook portion and prevents rotation of the rotating member.

10. A cargo-loading apparatus comprising:
a body defining a space for accommodating cargo;
at least first moving unit and a second moving unit connected to the body and disposed beneath the body;
a first plate positioned between the body and the at least first moving unit and a second moving unit and having at least one first fastening portion including vertical projections or grooves; and
a second plate positioned below and facing the first plate and having at least one second fastening portion formed to be vertically fastened to the at least one first fastening portion.

11. The cargo-loading apparatus of claim 10, wherein the second plate includes a first rail groove along which the first moving unit slides in a Y-axis direction, and a second rail groove along which the second moving unit slides following the first moving unit.

12. The cargo-loading apparatus of claim 11, wherein the first rail groove and the second rail groove each include a locking groove configured to stop sliding movement of the first and second moving units, respectively.

13. The cargo-loading apparatus of claim 12, wherein each locking groove is deeper than a corresponding rail groove to reduce acceleration of the sliding movement of the first and second moving units, and wherein a transition portion between the rail groove and the locking groove is inclined to reduce impact.

14. The cargo-loading apparatus of claim 10, wherein the first moving unit comprises front wheels capable of rotation, and the second moving unit comprises rear wheels incapable of rotation and vertically movable depending on a direction of the front wheel.

15. A load-carrying apparatus comprising:
a body defining a space for receiving a load;
a plate portion connected to the body and disposed at a bottom portion of the body, the plate portion including at least one tool-receiving opening configured to receive an external lifting tool;
at least two moving units disposed beneath the plate portion and configured to transport the body and plate portion while supporting the load, the at least two moving units being foldable and unfoldable; and
a folding-transfer member positioned within a spacing and at a height of at least two of the moving units and configured to move the plate portion while folding the moving units.

16. The load-carrying apparatus of claim 15, wherein each moving unit of the at least two moving units is connected to the plate portion by a receiving portion and a hinge portion, and wherein a spring is disposed between a wheel-axle of the moving unit and the receiving portion, the spring being wound around a hinge-shaft portion to bias the moving unit in a folding direction.

17. The load-carrying apparatus of claim 15, wherein the folding-transfer member comprises:
a fixed member having a height smaller than a length of the moving unit and positioned between at least two of the moving units;
a roller member configured to transmit movement of the plate portion in a folded state as the moving unit travels; and
a fixed-contact member configured to contact a folding-contact portion of the moving unit to initiate folding of the moving unit as the moving unit passes.

18. The load-carrying apparatus of claim 17, wherein contact between the moving unit and the fixed-contact member depresses a button to release a spring-locking device, allowing the moving unit to fold under a biasing force of the spring.

19. The load-carrying apparatus of claim 15, wherein the moving unit is automatically restored or manually restored to an unfolded state after use.
